(19) United States
(12) Patent Application Publication
(10) Pub. No.: US 2024/0089641 A1
(43) Pub. Date: Mar. 14, 2024

(54) Optical Network and Node Using Timeslotted Reception

(71) Applicant: Nippon Telegraph and Telephone Corporation, Tokyo (JP)

(72) Inventors: Ibrahim Salah, Musashino-shi, Tokyo (JP); Toshikazu Hashimoto, Musashino-shi, Tokyo (JP)

(21) Appl. No.: 18/262,046

(22) PCT Filed: Feb. 19, 2021
(86) PCT No.: PCT/JP2021/006454

§ 371 Date: Jul. 19, 2023

(51) Int. Cl. H04Q 11/08; H04B 10/27; H04Q 11/04

(52) U.S. Cl. CPC H04Q 11/08; H04B 10/27; H04Q 11/0442

(57) ABSTRACT

A new DC network structure is proposed that addresses various limitations of ASIC switches. In an optical network of the present disclosure, a slight time domain limitation is introduced for transmission from a network node to a same destination node. Data transmission and reception operate in a time slot scheme. A switching bandwidth in the ASIC switch has a bandwidth corresponding to average incoming traffic of a plurality of nodes, and includes a storage medium that stores and processes traffic exceeding the bandwidth. An average bandwidth for the reception ASIC switch can also be set to a bandwidth in which the maximum incoming bandwidth to the node is reduced by a coefficient F. Limiting the bandwidth of the reception ASIC switch can reduce the power consumption of the node, which is beneficial for network scalability.

### BACKGROUND ART

The present invention relates to an optical network, an optical node used therein, and an optical transmission scheme.

A data center is a general term for facilities specialized in installation and operation of computers (main frame, mini computer, server, and the like), data communication devices, and the like. Data center (DC) networks have grown rapidly to provide a wide range of services while accommodating significant increases in traffic volume. Despite such a significant increase in traffic volume, the basic structure of the network has not changed significantly.

FIG. 1 is a diagram illustrating a configuration of a DC network in a conventional technology. A typical DC network includes a plurality of layers, and has a configuration of a three-layer DC network as illustrated in FIG. 1, for example. The three-layer DC network 100 includes a switch 101, an optical link 102, a switch 103, an optical link 104, a top of rack (ToR) switch 105, and a server 106 from the upper layer side. The switches 101 and 103 each include upper and lower electrical switches and include optical links 107 and 108 connecting the upper and lower electrical switches. Therefore, in the DC network of FIG. 1, there are eight hops between the two ToRs. Optical-electrical-optical (OEO) conversion is performed over a wide range of each electrical switch.

In such a DC network 100, data is transmitted as an optical signal on a link connecting network nodes including one or more servers. At each node, the optical signal is converted into an electrical signal and switched by an electrical switch, that is, an application specific integrated circuit (ASIC) switch. The switching capacity of the ASIC switch continues to increase significantly, and one with capacity of 12.8 Tb/s is currently reported.

Non Patent Literature 1: White Rabbit project webpage, Internet <URL:https://www.ohwr.org/project/white-rabbit/wikis/home>

Non Patent Literature 2: K. Clark et al., “Sub-Nanosecond Clock and Data Recovery in an Optically-Switched Data Centre Network, 2018 post-deadline paper in ECOC 2018, Italy

### SUMMARY OF INVENTION

### Technical Problem

However, it is considered that the increase of the switching capacity of the ASIC switch reaches a limit at some point. This is because it has been more difficult to further reduce the size of a complementary metal oxide semiconductor (CMOS) transistor which is a constituent unit of the ASIC switch. Although a post-plane CMOS fabrication process for making the CMOS transistors smaller is desired, such a process is technically difficult and very costly.

A more urgent issue is the demand for a very high data rate for an optical signal input to or output from the ASIC switch. In order to support a high data rate, co-package mounting of a transceiver and an ASIC switch instead of a conventional pluggable transceiver has attracted attention in recent years. However, even when such an advanced approach is adopted, problems of large power consumption and heat generation remain.

The amount of heat generated by the SAIC switch has already exceeded the limit of the conventional air-cooling system, and a water-cooling system is required to handle heat dissipation of the ASIC switch. The water-cooling system can provide some power consumption margin for the ASIC switch, but is not a long-term solution. Having thus faced a significant increase in the data rate of optical signals in the ASIC switch, the problem of space density and power limitation has become a serious obstacle.

The fundamental solution to all the problems as described above is to avoid optical-electrical-optical (OEO) conversion, which is unavoidable for ASIC switches, or reduce the frequency of the OEO conversion. Therefore, it is necessary to introduce optical switching into the DC network structure.

The present invention has been made in view of such a problem, and an object thereof is to propose a new DC network structure that addresses various limitations of an ASIC switch.

### Solution to Problem

To achieve such an object, an aspect is an optical network including: an optical core portion having a full mesh network configuration; and a plurality of nodes connected to the optical core portion, the plurality of nodes being divided into a plurality of groups, one group including up to m nodes, in which each of the plurality of nodes includes an ASIC switch that switches and routes an electrical signal corresponding to an optical signal received from the up to m nodes to a plurality of servers, the ASIC switch having switching capacity corresponding to average incoming traffic of the plurality of nodes, is addressed by any node in a group to which a source node belongs only in a time slot associated with the group to which the source node belongs in a reception cycle period including a plurality of time slots, and in one or more idle time slots subsequent to the plurality of time slots, does not receive an optical signal from any of the source node and processes traffic beyond the average incoming traffic.

An optical network of another aspect is an optical network including: an optical core portion having a full mesh network configuration; and a plurality of nodes connected to the optical core portion, the plurality of nodes being divided into a plurality of groups, one group including up to m nodes, in which each of the plurality of nodes is addressed by any node in a group to which a source node belongs only in a time slot associated with the group to which the source node belongs in a reception cycle period including a plurality of time slots, includes ASIC switches that switch and route an electrical signal corresponding to an optical signal received from the up to m nodes to a plurality of servers, and includes as the ASIC switches, a main switch that has switching capacity corresponding to average incoming traffic of the plurality of nodes, and operates in synchronization with the time slot, and an auxiliary switch that has switching capacity capable of processing traffic exceeding the average incoming traffic and operates regardless of the time slot.

The above-described optical network also has an aspect as an invention of a network node in an optical network.

### Advantageous Effects of Invention

An optical network of the present disclosure simplifies a node configuration and reduces capacity and power consumption of an ASIC switch. The optical network copes with large-scale and low power consumption of the optical network.

### BRIEF DESCRIPTION OF DRAWINGS

FIG. 1 is a diagram illustrating a configuration of a DC network in a conventional technology.

FIG. 2 is a diagram illustrating a basic configuration of a DC network according to the present disclosure.

FIG. 3 is a diagram for explaining a problem of a node in a peripheral part of an optical network of a conventional technology.

FIG. 4 is a diagram conceptually illustrating a configuration of an optical network and a reception node of the present disclosure.

FIG. 5 is a diagram illustrating a reduction effect of a receiver obtained in the optical network of the present disclosure.

FIG. 6 is a diagram for explaining a data reception operation in a reception node of the optical network.

FIG. 7 is a diagram illustrating another example of a reception operation of networks having different group configurations.

FIG. 8 illustrates exemplary network and node specifications according to the present disclosure.

FIG. 9 is a diagram for explaining a concept of different reception bandwidths required by a reception node.

FIG. 10 is a diagram for explaining possible combinations of a plurality of nodes having different average connection numbers.

FIG. 11 is a diagram for explaining effective BW degradation between a node pair due to network division.

FIG. 12 is a diagram for explaining different bandwidths of traffic in a DC network.

FIG. 13 is a diagram for explaining a concept of a reduced bandwidth of a reception ASIC switch.

FIG. 14 is a diagram illustrating a relationship between an average bandwidth BW_{switch_avg} and a reception cycle period T.

FIG. 15 is a diagram for explaining an extended reception cycle period according to introduction of a coefficient F.

FIG. 16 is a configuration diagram of a node including a modified switch according to the introduction of the coefficient F.

FIG. 17 is a configuration diagram of a node that reduces a delay in the modified switch.

### DESCRIPTION OF EMBODIMENTS

The following disclosure includes a DC network structure that achieves end-to-end optical transmission between a desired pair of nodes with optical switching at a core portion and electrical switching only at a network peripheral part. The inventors have proposed DC network structures that more efficiently utilize electrical switches facing performance limitations. A novel mechanism is proposed herein that flexibly addresses capacity (bandwidth (BW)) limitations in electrical switches with a novel approach. First, an outline will be described of a DC network and a node as a basic configuration that limit a bandwidth at an incoming node by a time slot operation. Subsequently, a novel mechanism for dealing with the performance limitation of the ASIC switch in the DC network of the basic configuration will be described.

### Core Portion Configuration of Optical Network

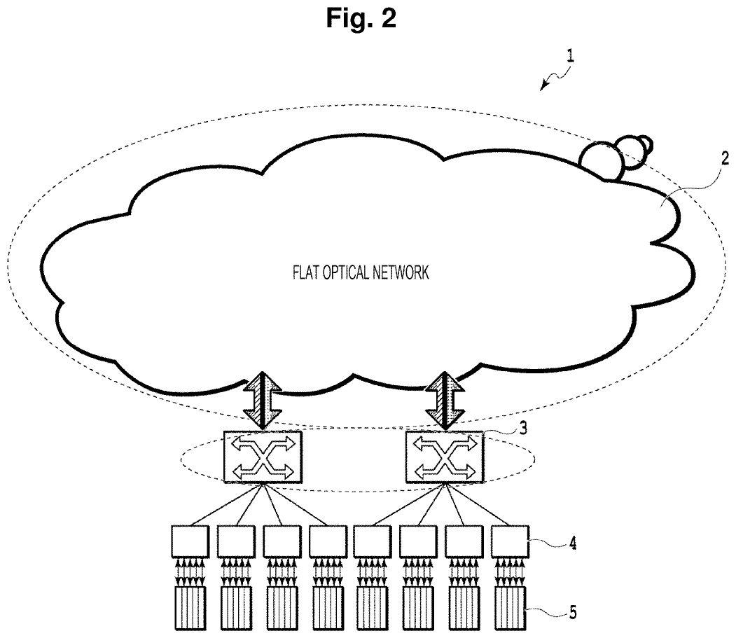

FIG. 2 is a diagram illustrating a basic configuration of a DC network according to the present disclosure. Although details will be described later, a DC network 1 includes a flat optical network 2 that is a core portion of the entire network, and an SW unit 3, a ToR 4, and a server 5 that are in a peripheral part of the entire network. These elements in the peripheral part constitute a part of the node. In FIG. 2, two nodes are shown with one node including four ToRs for simplicity, but it should be understood that there are many other nodes in the periphery of the flat optical network 2. As described above, optical switching is used in the flat optical network 2 that is a core portion, and electrical switching is used only in the SW unit 3 that is a peripheral portion thereof and a peripheral side thereof. The optical network structure in FIG. 2 is scalable and supports highly dynamic connection between any pair of nodes. Depending on the number of nodes included, the core portion of the network can be implemented as a physical full mesh network or as a full mesh-like network.

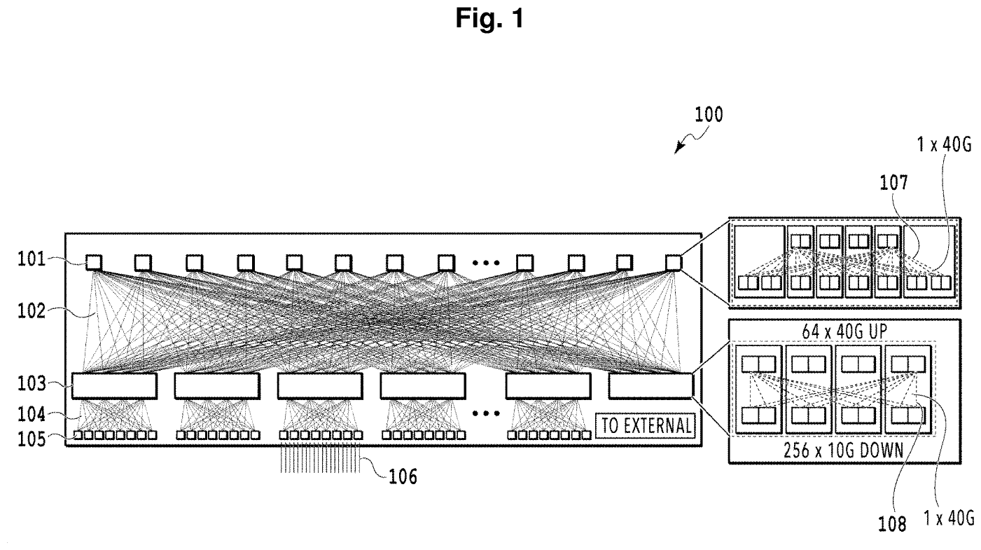

The full mesh network or the full mesh-like network as a premise of the DC network of the present disclosure illustrated in FIG. 2 is different from the DC network 100 of the conventional technology of FIG. 1 in that only optical switching is used in the core portion. In the flat optical network 2 of FIG. 2, only optical switching is used without performing the OEO conversion in the SWs 101 and 103 of each layer of FIG. 1.

In the following disclosure, a novel and practical data reception mechanism and its associated hardware at each node will be disclosed. These replace some of a large number of optical receiver units and complex high-capacity switching configurations that have been required so far. A basic approach to the configuration of the optical network of the present disclosure consists in introducing a slight time domain limitation for transmission from a network node to a same destination node. Specifically, the network of the present disclosure operates in a time slot scheme.

### Problem of Reception in Peripheral Part of Optical Network

In a case where a physical full mesh connection is achieved in the DC network of N nodes in the conventional technology illustrated in FIG. 1, since the number of transmitters, receivers, and bidirectional optical links is N×(N−1), enormous resources are required. In such a full mesh network or a full mesh-like network, a large-scale switching configuration is required in each node. In a full mesh or full mesh-like network with N nodes, any destination node in the network can be simultaneously addressed by any number of source nodes up to N−1. Here, “addressing” includes not only specifying and designating a destination node of a counterpart as a communication destination by a source node in order to set a communication link between nodes, but also actually setting a communication link and performing communication.

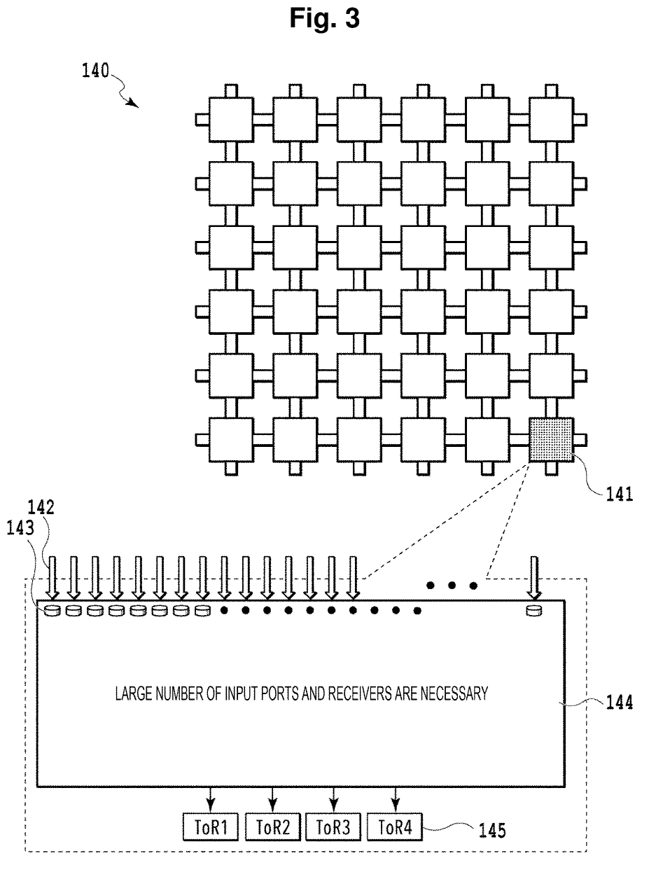

FIG. 3 is a diagram for explaining a problem of a node in a peripheral part of an optical network of a conventional technology. FIG. 3 conceptually illustrates the full-mesh optical network 140, and represents the flat optical network 1 illustrated in FIG. 2 as a set of nodes. In the optical network 140, a large number of nodes are connected to each other. Although FIG. 3 illustrates four nodes adjacent to one node are interconnected, this symbolically indicates that the node is connected to all nodes in the optical network.

Here, attention is paid to one reception node 141. The reception node 141 includes an interface unit 144 with the optical network side, and is further connected to the ToR 145. The interface unit 144 includes a receiver 143 that receives a plurality of optical signals 142 arriving at the same time. When the optical network 140 includes N nodes, (N−1) receivers 143 corresponding to a large number of ports are required in the reception node 141 in order to process all data communications that arrive simultaneously. The interface unit 144 further includes a reception ASIC switch having a large-scale configuration (not illustrated). As described above, a very high data rate is required for an optical signal input to or output from the ASIC switch. It can be understood from FIG. 3 that a large number of receivers and a large ASIC switch are required in all reception nodes. As described above, the nodes in the peripheral part of the flat optical network have problems of the necessity of a huge number of receivers and the capacity limit of the ASIC switch. To solve these, in the optical network of the present disclosure, introduction of a slight time domain limitation for data transmission from a network node to a same destination node is proposed.

### Proposed Network Method

### A. Reducing the Number of Receivers

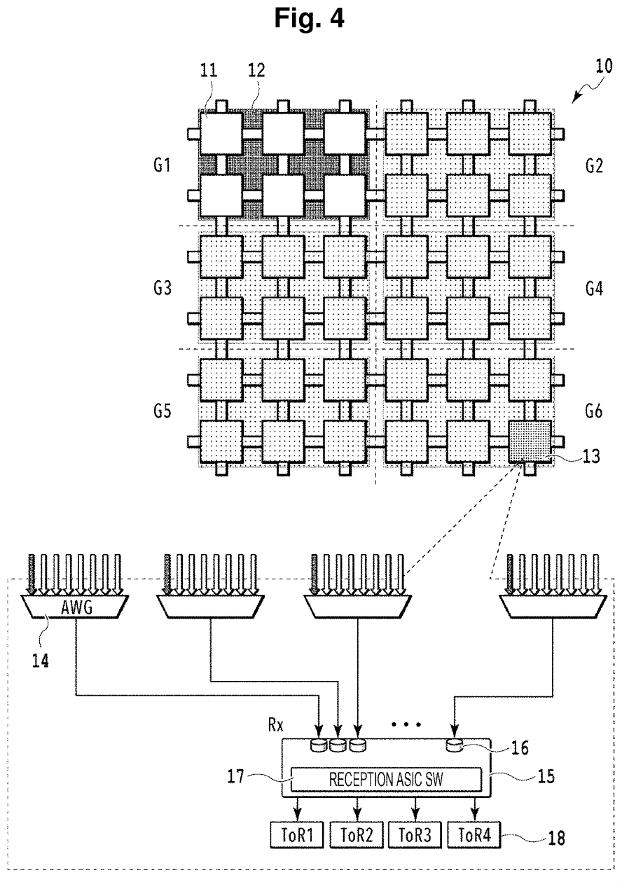

FIG. 4 is a diagram conceptually illustrating a basic configuration of an optical network and a reception node of the present disclosure. As similar to FIG. 3, FIG. 4 conceptually illustrates a full mesh or full mesh-like optical network 10. For simplicity, the optical network 10 includes N (for example, 36) nodes and, as an example, consider data transmission between a transmission source node or source node 11 and a destination node or reception node 13. As a matter of course, in the following description, the source node can also serve as a reception node, and the names are merely distinguished according to the operation and function to be described. Accordingly, it should be noted that the source node similarly has the functions and configurations described in the reception node.

In the optical network 10, all N network nodes as source nodes are divided into a large number of groups (d), and a group to which each source node belongs is defined. In the example of FIG. 4, six groups of the first group (G1) to the sixth group (G6) are defined, and the source node 11 belongs to the first group 12.

Reception of data communications at any node, that is, any reception node, is performed separately for each group to which the source node belongs, in time slots of fixed duration T, as described below. That is, a reception node may be addressed by any source node belonging to a group of source nodes only during time slots assigned to the group of source nodes. Specifically, the reception node 13 receives data from the source node 11 during a time slot assigned to G1 to which the source node 11 belongs. The reception node 13 is further addressed during the same time slot from the other five source nodes belonging to G1.

In FIG. 4, nodes belonging to one group are shown here as being close for purposes of illustration, but are generally spatially distributed throughout the network. The reception node sequentially and continuously receives data from different groups every time slot, and a time of a cycle in which reception from all the groups is completed is d (division number)×T (TS time). In the case of network division in which the number of nodes in each group is uniform, the number m of nodes belonging to the same group is m=N/d.

As described above, in a case where a time limit is set for data reception in the reception node, it is necessary to cope with the maximum possible simultaneous incoming traffic by installing m receivers in any reception node. Here, the maximum transmission bandwidth (BW) of each node is set as Bₒᵤₜ. The term “bandwidth” used in the following description means a transmission bandwidth that can be received or transmitted by a node, and may be understood as a transmission speed (transmission rate). It should be noted that the term “bandwidth” is a broad concept that means a capacity of a communication resource for data transmission determined according to a modulation scheme or a signal configuration of optical communication.

In general, a bandwidth that can be emitted by a node and a bandwidth that can be received by the node are the same, and Bout is also a maximum reception bandwidth. During the assigned time slot T, the entire band of this Bₒᵤₜ can be used for a specific reception node. However, a source node can address the same reception node again only after the elapse of one reception cycle. For a sufficiently long observation time, the effective BW, which is the substantial bandwidth between the two nodes, is Bₒᵤₜ/d. In general, increasing the number of node groups d in a network reduces the effective BW between any pair of nodes. This new mechanism for increasing the value of the effective BW is described below as addressing the performance limitations of electrical switches in the optical network and reception node of the present disclosure of FIG. 4.

By introducing a slight time domain limitation on the above-described data transmission from the source node to the same reception node, the number of receivers can be significantly reduced in the node in the optical network of the present disclosure of FIG. 4 as compared to the node in the conventional technology configuration illustrated in FIG. 3.

Referring back to FIG. 4, details of the reception node 13 are illustrated as a detailed diagram on the lower side, and will be described in comparison with the configuration of the reception node according to the conventional technology illustrated in FIG. 3. In the node 13 in the optical network of the present disclosure, an arrayed waveguide grating (AWG) 14 that multiplexes optical signals from different wavelengths (d different groups) is added at a node front portion that receives an input optical signal of reception data. In order to receive data from N nodes simultaneously, each of the AWGs 14 has at least d of input ports corresponding to the number of groups, and a number m of nodes in one group is provided at the front portion of the node 13. The multiplexed reception data passing through the m AWGs 14 is supplied to an interface unit 15 as similar to that in the conventional technology and input to a receiver 16. Here, the number of receivers 16 in the interface unit 15 is greatly reduced to 1/m as compared with the configuration of the conventional technology in FIG. 3.

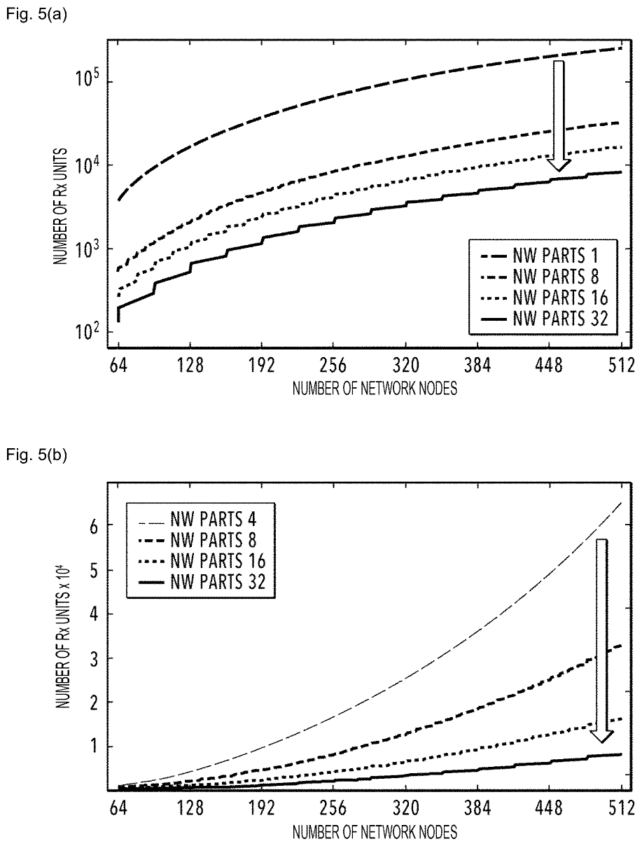

FIG. 5 is a diagram illustrating a reduction effect of receivers achieved by dividing nodes in the optical network of the present disclosure into groups. In FIG. 5, the relationship between the number of receivers (Rx units) in the node and the number of all the nodes is illustrated using the number of divisions, that is, the number of groups as parameters, and the number of receivers on the vertical axis is illustrated in logarithmic display in (a) and in linear display in (b). Regardless of the number of nodes, the required number of receivers can be significantly reduced as the number of divisions increases.

Accordingly, the optical network of the present disclosure may be implemented as including: an optical core portion 2 having a full mesh network configuration; and a plurality of nodes connected to the optical core portion, the plurality of nodes being divided into a plurality of groups, one group including up to m nodes, in which each of the plurality of nodes 13 is addressed by any node in a group to which a source node 11 belongs only in a time slot associated with the group to which the source node belongs. Further, the optical network of the present disclosure may be implemented such that each of the plurality of nodes includes: m arrayed waveguide gratings (AWGs) 14, the AWGs including a plurality of input ports configured to receive corresponding optical signals from the up to m nodes belonging to the same group, and having wavelengths used by one or more source nodes of the up to m nodes set to match operating wavelengths of the plurality of input ports; m receivers 16 connected to output multiplexing ports of the AWGs; and an ASIC switch 17 that switches electrical signals from the m receivers and routes the electrical signals to a plurality of servers 18.

It should be noted that although the above description describes the present invention as the invention of the optical network, the present invention also has an aspect of the invention of the network node. For example, the present invention may be implemented as a node connected to an optical core portion having a full mesh network configuration, the node is divided into a plurality of groups together with other plurality of nodes connected to the core portion, one group including up to m nodes, in which each of the up to m nodes is addressed by any node in a group to which a source node belongs only in a time slot associated with the group to which the source node belongs.

Returning to the basic configuration of the reception node of FIG. 4, the interface unit 15 of the reception node 13 includes a reception ASIC switch 17 as in the configuration of the conventional technology. However, as will be described later, the switching capacity is greatly reduced as compared with the conventional technology. The configuration of the interface unit in the reception node is greatly simplified as compared to the conventional technology in terms of the number of receivers and the capacity of the reception ASIC switch. More detailed reception node operation and reception ASIC switch bandwidth reduction are described.

### B. Simplified Reception Switching

Using B out as the maximum outgoing bandwidth of one node and the number of nodes m in one group, the maximum BW received by the node having the basic configuration of FIG. 4 in any time slot is m x Bout

This maximum BW is reduced to approximately 1/d as compared to the BW in a case of receiving data in fully asynchronous operation (for example, optical packet switching) without the use of a time slot. As illustrated in the configuration of the reception node in FIG. 4, the input data to the reception node needs to be switched to a desired ToR switch 18. The reception ASIC switch 17 is used for this switching.

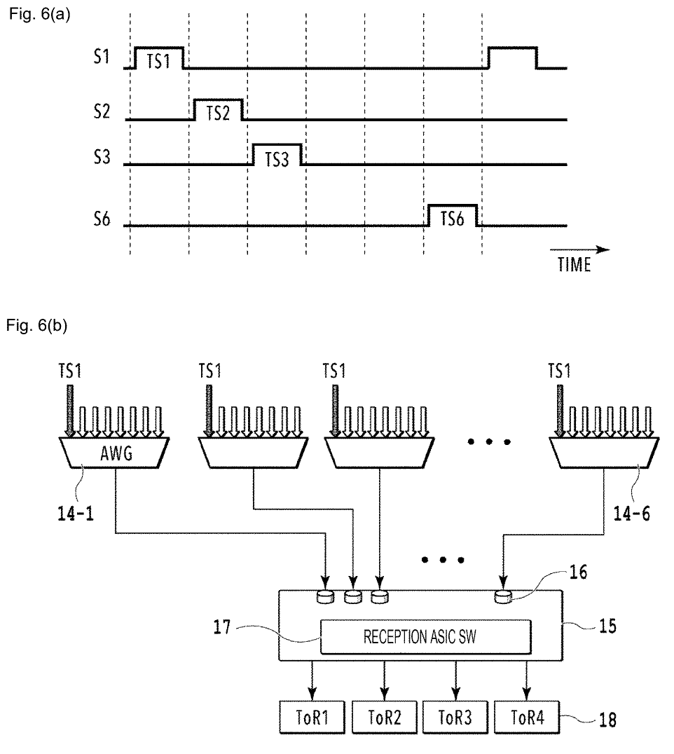

FIG. 6 is a diagram for explaining a data reception operation in a reception node having the basic configuration in the optical network of the present disclosure. (a) of FIG. 6 illustrates a time slot configuration, and (b) is a diagram for explaining a switching operation when data is received in TS 1. The ASIC switch 17 of the interface unit 15 in (b) has m ports on the input side facing the network and ports of the number corresponding to the number of ToR switches 18 on the other output side. When a plurality of links are used for each ToR switch, there are ports of the number corresponding to the plurality of links.

The time slot configuration in (a) of FIG. 6 illustrates an example in which all the nodes of the optical network 10 illustrated in FIG. 4 are divided into six groups, and m nodes belonging to each group perform reception only in corresponding time slots. For example, data from six source nodes belonging to a first group is received by a corresponding port of each AWG only in TS 1 as illustrated in (b). Data from m different source nodes is received in m AWGs 14-1 to 14-6 as many as the number of nodes present in one group. Accordingly, in a particular time slot, each of the m input ports of the ASIC switch 17 can capture data received from different source nodes in the same group. That is, data can be simultaneously received from all m source nodes in the same group.

As illustrated in (b) of FIG. 6, to simplify switching processing of different groups, an AWG is connected to each port on an input side of the ASIC switch 17, and nodes of the same group are connected to different AWGs. During the assigned time slot, only nodes in the allowed group are active, while all nodes in the other groups do not transmit to the destination node.

For the sake of illustration, it is assumed that the same wavelength λ1 is used by all nodes of an active group (for example, G1) in TS 1. The input signal at wavelength λ1 is passively routed by a plurality of (m) AWGs towards the ASIC switch 17. That is, routing is performed by connecting different nodes in the same group and ports of corresponding wavelengths of m AWGs. In the next TS 2, it is assumed that all the nodes in the next active group (G2) transmit at λ2. Also in this case, the input signal at λ2 from each node belonging to G2 is passively routed by a plurality of (m) AWGs towards the ASIC switch 17.

In general, nodes in the same group do not need to transmit at the same wavelength. It is sufficient that a plurality of wavelengths used by nodes of different groups connected to the same AWG are adjusted to different wavelengths so as not to cause contention. As described above, when the same wavelength is used in all the nodes in the same group, the configuration of the AWG in the reception node can be made common.

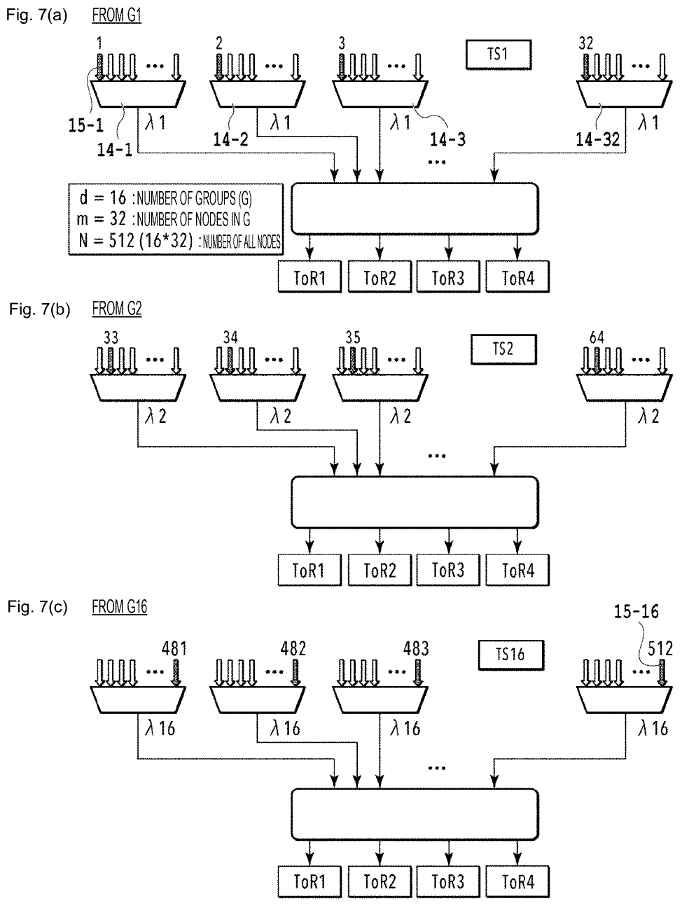

FIG. 7 is a diagram illustrating another operation example of reception switching in a network having a different group configuration. FIG. 7 illustrates (a) an example of reception in TS 1 from G1, (b) an example of reception in TS 2 from G2, and (c) an example of reception in TS 16 from G16 for a case where the total number of nodes N=512, the number of groups (the number of divisions) d=16, and the number of nodes in the group m=32. In each drawing, the node number (1 to 512) is indicated for the input of the AWG. Also in this example, 32 nodes in the same group use the same wavelength, but the wavelength may be different for each AWG. The use of 32 AWGs 14-1 to 14-32 at a reception node allows simultaneous reception of data from 32 different nodes belonging to the same group in the same time slot. In this configuration, it is sufficient that 32 receivers corresponding to 32 AWGs are provided in the interface unit of the reception node.

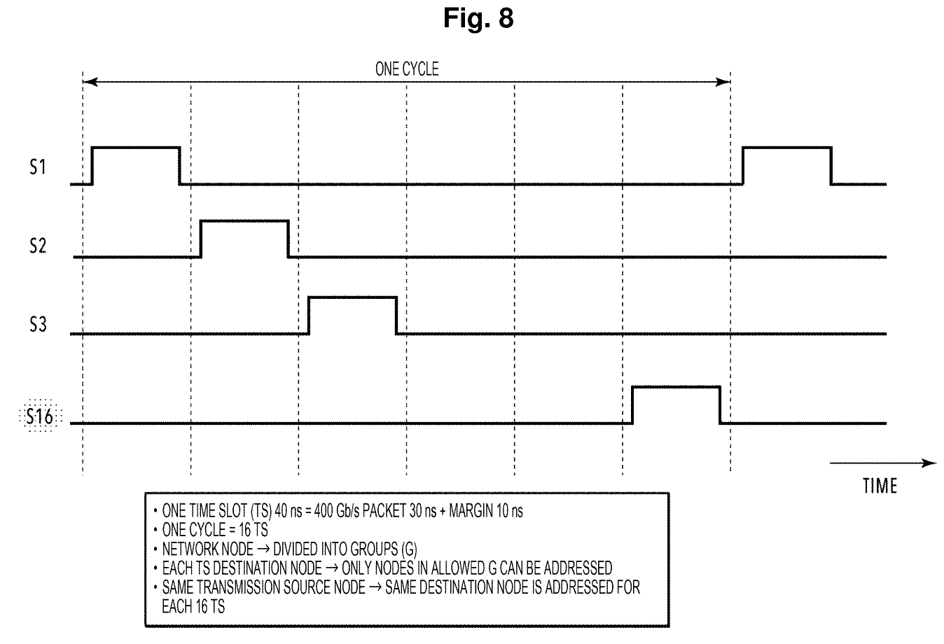

FIG. 8 illustrates exemplary network and node specifications according to the present disclosure. An example of parameters of a configuration with 16 divided networks and corresponding 16 time slots is illustrated. Specifically, one time slot has a length of 40 ns including 30 ns corresponding to a 400 Gb/s packet and 10 ns of a margin. One cycle is divided into 16 time slots, and 512 network nodes are divided into 16 groups. The number of nodes in one group is 32. The destination (reception) node of each time slot is addressed only by the allowed group. The same source node may address the same destination node every 16 time slots.

### C. Reduction of BW of Reception ASIC Switch

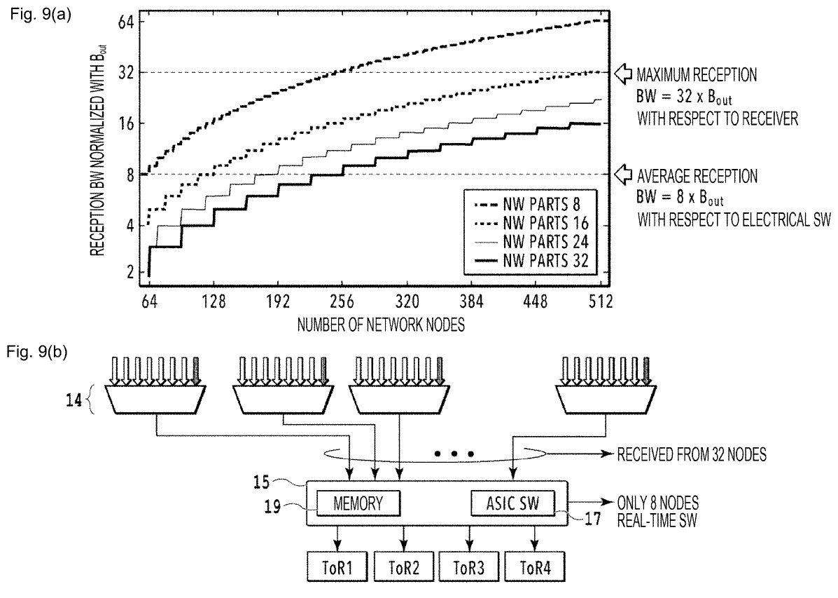

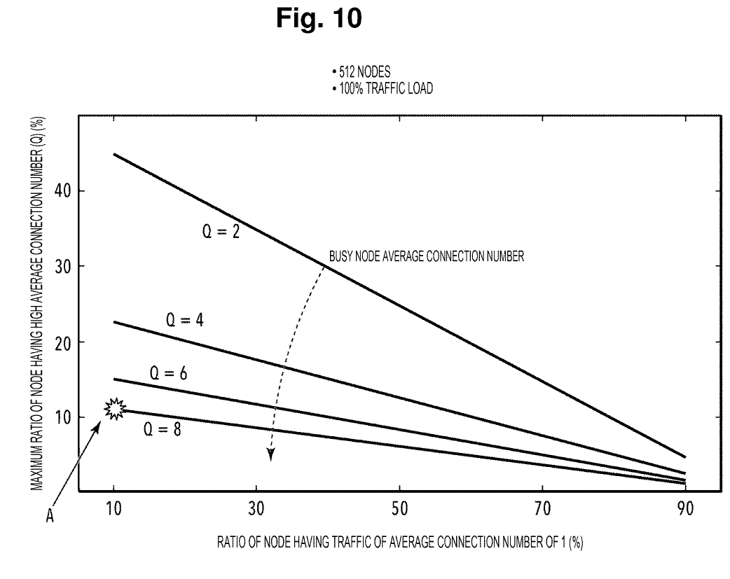

As described in the description of FIG. 4, in the node having the basic configuration in the optical network of the present disclosure, the capacity of the reception ASIC switch is significantly reduced as compared with the conventional technology. Specifically, the capacity of the reception ASIC switch is set to a value that matches the average incoming traffic or slightly exceeds the average incoming traffic. A memory associated with the reception ASIC switch is provided to process traffic exceeding this switching capacity with a slight delay. With reference to FIGS. 9 and 10, description will be made below that substantially sufficient traffic can be handled in the basic node of the flat optical network of the present disclosure even if the capacity of the reception ASIC switch is reduced as compared with the node in the conventional technology.

In order to reduce the switching load of the ASIC switch in the node, the inventors have considered the traffic input to the reception node, in other words, the input bandwidth BW of the reception node, classified into two categories with different requirements. The two categories of traffic are: (a) traffic that needs to be switched in real time without additional delay; and (b) traffic that does not need to be switched all in real time at the reception ASIC switch because it already exceeds the processing capability of the connected server. The average reception BW is assigned to the traffic of (a), and the maximum reception BW is assigned to the traffic of (b). In the following, how the switching capacity of the reception ASIC switch, that is, the transmission band of the reception ASIC switch, can be assigned to different BWs corresponding to two categories of traffic is considered.

In the case of the maximum reception BW that does not require real-time processing, introducing a storage medium (memory) for partially storing the reception data of the reception node ensures that the reception data is not lost or does not need to be retransmitted. The main advantage of introducing a storage medium is that the switching capacity of the reception ASIC switch can be reduced instead of accepting the sacrifice of introducing extra additional delay.

FIG. 9 is a diagram for explaining a concept of different reception bandwidths required by a reception node. In (a) of FIG. 9, the relationship between the reception BW normalized with the bandwidth B out that can be received by one node and the number of nodes N of the network is illustrated using the number of groups (the number of divisions of the network) d as a parameter (d=8, 16, 24, 32). Here, the bandwidth B out of the reception node is the same as the maximum outgoing bandwidth of the source node described in FIG. 4. Taking a network with 512 nodes divided into 16 groups as an example, each reception node should include 32 (=512/16) receiver units to accommodate a normalized maximum BW that is 32 times the BW that can be generated by the node itself. Assuming a normalized average reception BW of 8, the switching capacity of the reception ASIC switch is reduced by 8/32 as compared to the case of the maximum switching load. (b) of FIG. 9 is a diagram for explaining the above-described two reception bandwidths, and illustrates that at the front of the interface unit to which the output of the AWG is connected, 32 receivers are required to reliably and simultaneously receive all input data from 32 nodes. On the other hand, (b) of FIG. 9 illustrates that the reception ASIC switch in the interface unit includes an average reception BW for eight nodes by including a memory, and it is sufficient that real-time switching processing for eight nodes is performed.

While the average reception BW may vary from node to node, except for a limited number of specific nodes, the average reception BW can typically be set significantly lower than the maximum reception BW. This is due to the natural balance of traffic in the flat optical network 2 as a premise in the DC network of the present disclosure illustrated in FIG. 2. This balance mechanism can be described as a property of traffic in a flat optical network as follows.

FIG. 10 is a diagram for explaining possible combinations of a plurality of nodes having different average connection numbers. Here, a property of traffic as a premise in the flat optical network will be described. In a flat optical network with uniform connectivity and 100% traffic load, the average number of received connections per node is 1. From this state, when the node receives more connections on average, the average number of received connections starts to deviate from the state of 1. In the flat optical network, this means that traffic received by a certain node is then directed to a new busy node. As more nodes become busy, the average connection number of remaining nodes naturally decreases.

In the example of FIG. 10, in order to numerically elucidate the idea of this balance mechanism, simulation was performed on an example of a network with 512 nodes and 100% traffic load. To simplify the calculation without loss of generality, the network nodes were classified into three categories. That is, there are three nodes: (a) a busy node in which the average number of received connections is Q (>1); (b) a non-busy node in which the average number of received connections is 1; and (c) a node that has not received data. In the horizontal axis of FIG. 10, the ratio of non-busy nodes having the traffic of category (b) is indicated in %. In the vertical axis, the maximum ratio of busy nodes corresponding to the traffic of the category (a) described above and having the average connection number Q larger than 1 is indicated in % Therefore, the graph of FIG. 10 indicates the relationship between the node ratio (horizontal axis) of the category (b) satisfying the condition of the 100% traffic load and the node ratio (vertical axis) of the category (a), using the value of the average connection number Q of the busy nodes of the category (a) as a parameter.

As illustrated in FIG. 10, when the value of the average connection number Q of the busy nodes increases to 2, 4, 6, and 8, the maximum ratio of the busy nodes of the category (a) having such an average connection number Q significantly decreases.

Specifically, the point indicated by A represents an extreme condition that the ratio of the non-busy nodes of the category (b) with the number of connections of 1 is 10%, and the ratio of the nodes of the category (c) with the number of connections of 0 without receiving data is 79%. It can be seen that even under such conditions, up to 11% of the nodes (100−10−79=11) may have an average connection number Q of 8. At this point A, the network with 100% traffic load is established in such a node distribution state that the majority (79%) of the nodes have not received data and the remaining nodes are a small number (10%) of non-busy nodes (Q=1) and a small number (11%) of nodes having a traffic concentration with the average connection number Q=8. In this example, it is strongly shown that in terms of the maximum reception switching capacity of the reception ASIC switch, a reception ASIC switch with only a small capacity, on the order of the average incoming traffic, can also be used sufficiently. The simulation of the traffic load in FIG. 10 shows that in a network in which 512 nodes are divided into 16 groups, if the capacity of the reception ASIC switch is set to the normalized average reception BW=8 corresponding to the average reception traffic, the traffic can be sufficiently processed.

As illustrated in (b) in FIG. 9, the reception node having the basic configuration in the optical network of the present disclosure includes a plurality of AWGs 14 and an interface unit 15 that passively route reception data from different source nodes. A receiver and the reception ASIC switch 17 are provided at the front of the interface unit 15, and a storage unit (memory) 19 interlocked with the reception ASIC switch 17 is further provided. The capacity of the reception ASIC switch 17 may match or slightly exceed the average reception traffic and the storage means 19 may be utilized to handle traffic above this switching capacity with a slight delay.

As described above, the optical network having the basic configuration of the present disclosure operates in a time slot scheme for transmission from the source node to the same destination node in order to limit data reception at the reception node. A source node can address the same reception node again only after the elapse of one reception cycle. Due to the limitation of data reception, a substantial transmission rate is reduced, and an effective BW of data transmission between the node pair is degraded.

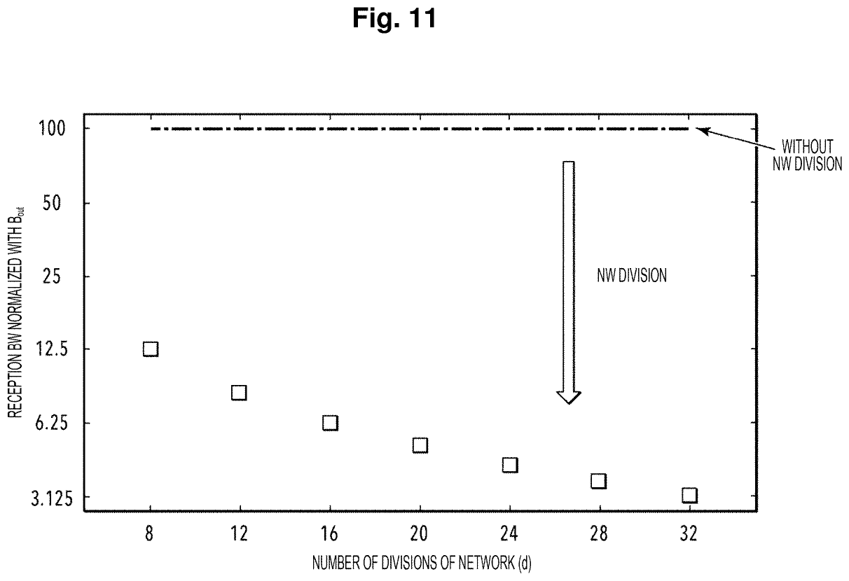

FIG. 11 is a diagram for explaining effective BW degradation between any node pair due to network division. The horizontal axis represents the number of divisions (the number of groups) d of the network, and the vertical axis represents the reception BW normalized by the B out of the maximum outgoing BW in the reception node. As illustrated in FIG. 11, the reception BW decreases with an increase in the number of network divisions d. For example, when the number of divisions d increases from 8 to 32, the reception BW decreases from 12.5% to 3.12%. A mechanism is required to compensate for such a decrease in effective BW between node pairs caused by network division. In order to solve the problem of the decrease in the effective BW in the optical network having the basic configuration, the inventors have proposed two solutions of a modification to the operation of the source node and a modification to the transmission path between any nodes. One solution was to allow the source node to reach the desired destination node in one or more time slots, and another solution was to set up another optical line between any pair of nodes to increase the effective BW.

In addition to solving the problem of the reduction in the effective BW between the node pair, it is proposed herein to make a modification to the configuration of the time slot or the configuration of the electrical switch of the reception node in the optical network having the basic configuration described above. From a new perspective different from the previous solutions, we propose a way to address performance limitations in ASIC switches.

### [Introduction of Coefficient F to Maximum Incoming Bandwidth BW_{in_max} of Reception Node]

With some compromise, if the maximum traffic can be maintained to be handled, the bandwidth BW_{switch_avg} of the reception ASIC switch in the network node can be set to a fraction F (0<F<1) of the maximum reception bandwidth BW_{in_max}. To address the rapidly increasing amount of traffic and the limitations of switching technologies as described in the beginning, it may be necessary to reduce the switching capacity (bandwidth) in the ASIC switch to a practically available value. Here, first, concepts of different bandwidths in each unit of the DC network of the basic configuration illustrated in FIG. 4 will be described.

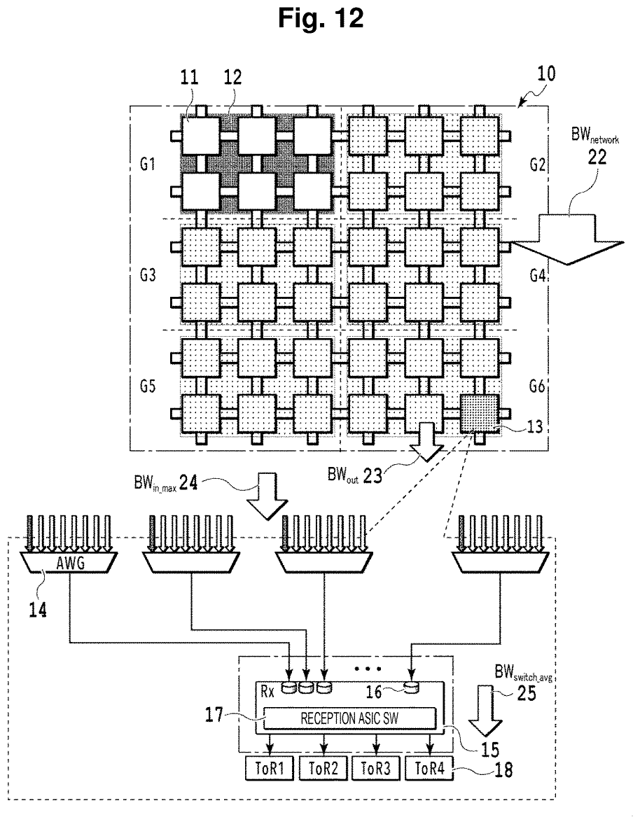

FIG. 12 is a diagram for explaining different bandwidths of traffic in a DC network. FIG. 12 illustrates the same basic configuration as the DC network of the present disclosure illustrated in FIG. 4. Various definitions of bandwidth seen from different perspectives are now shown in relation to network nodes.

(Definition 1) BWₒᵤₜ: total output bandwidth from each node

(Definition 2) BWᵢₙ₎ₘₐₓ: maximum incoming bandwidth of each node (to the reception switch)

(Definition 3) BW_{network}: total bandwidth of the network

Referring to FIG. 12, a total bandwidth BWₒᵤₜ of the entire network 10 is represented by an arrow 22, and a total output bandwidth BWₒᵤₜ from individual nodes is represented by an arrow 23. Assuming that the number of nodes in the network 10 is N, the following relationship holds.

BW_{network}=BWₒᵤₜ×N Equation (1)

In FIG. 12, the maximum incoming bandwidth BW_{in_max} of the reception node, including the reception ASIC switch whose performance limit is at issue, is represented by an arrow 24. As already described in FIGS. 9 and 10, the DC network of the present disclosure can include the storage means 19 interlocked with the reception ASIC switch 17. As a result, the switching capacity of the reception ASIC switch 17 may be set to match or slightly exceed the average reception traffic and the storage means 19 may be utilized to handle traffic above this switching capacity with a slight delay. In FIG. 12, the average bandwidth BW_{switch_avg} for the reception ASIC switch is represented by an arrow 25.

The inventors have considered that it is difficult to flexibly cope with a rapid increase in traffic and a restrictive situation of ASIC technology development by assigning the bandwidth of the maximum capacity available from time to time to the reception ASIC switch. The inventors have conceived of not only the bandwidth BW_{switch_avg} of the reception switch is set to match or slightly exceed the average reception traffic in advance, but also a wider range is set as a fraction F (Fraction: 0<F<1) of the maximum reception bandwidth BW_{in_max}. Therefore, in the DC network of the present embodiment, the average bandwidth BW_{switch_avg} for the reception ASIC switch 17 in FIG. 12 is set to the “reduced bandwidth” of the maximum incoming bandwidth BW_{in_max} by the coefficient F. In the configuration of the DC network in this embodiment that addresses the performance limits of the ASIC switch, the following relationship is further defined for the bandwidth of the ASIC switch.

(Definition 4) BW_{switch_avg}: reduced bandwidth of the main ASIC switch at the node

(Definition 5) coefficient F: ratio of reduced bandwidth BW_{switch_avg} to ASIC switch with respect to maximum incoming band BW_{in_max} to the node

The following equation is obtained from the above definition (5) of “reduced bandwidth”.

BW_{switch_avg}=F×BW_{in_max} Equation (2)

In the DC network configuration illustrated in FIG. 4, if it is difficult for the ASIC switch to satisfy the bandwidth corresponding to the required maximum reception bandwidth BW_{in_max} it can be said that it is reasonable to introduce “reduced bandwidth”. By introducing the coefficient F, it is possible to flexibly cope with the bandwidth of the practically available ASIC switch. Also, at the same time, the total bandwidth BW_{network} of the network can be increased by a factor of the same coefficient F. Further, by limiting the bandwidth of the reception ASIC switch, it is also possible to generally reduce the power consumption of the node. Introducing the coefficient F into the bandwidth of the reception ASIC switch in this way is beneficial for network scalability.

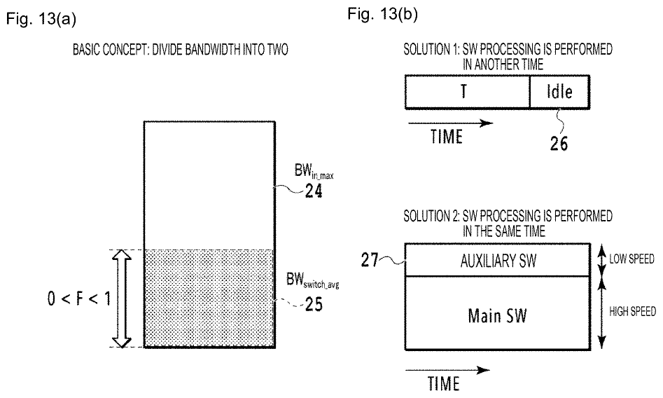

FIG. 13 is a diagram for explaining a concept of a reduced bandwidth of an ASIC switch in the DC network of this embodiment. (a) of FIG. 13 illustrates a relationship between the average bandwidth BW_{switch_avg} and the maximum incoming bandwidth BW_{in_max} in the reception node. As illustrated in FIG. 13, the average bandwidth BW_{switch_avg} 25 of the reception ASIC switch 17 is set to a fraction of the maximum incoming bandwidth BW_{in_max} 24 to the node, and the coefficient F divides the maximum incoming bandwidth BW_{in_max} 24 by 2. As described above (definition 5), the coefficient F represents the ratio between the maximum incoming bandwidth BW_{in_max} 24 and the average bandwidth BW_{switch_avg} 25 assigned to the ASIC switch, and is in the range of 0<F<1.

When the number of groups (division number) in the network 10 is d, the number of nodes m belonging to the same group is m=N/d. A reception cycle period in which reception from all the node groups is completed is defined as T.

A reception cycle in which reception from all node groups is completed is T, and from a configuration of the reception cycle T having time slot structures corresponding to the d groups, a maximum incoming bandwidth BW_{in_max} of each node may be represented by the following equation.

BW_{in_max}=BWₒᵤₜ×m=BW_{out×(}N/d) Equation (3)

Equation (3) is transformed by using Equation (1) and Equation (2), and from the viewpoint of the bandwidth, the number of groups d can also be represented by the following equation.

BW_{in_max=(}BW_{network}/N)×(N/d) d=BW_{network}/BW_{in_max} Equation (4)

As illustrated in FIGS. 6 and 8, assuming that one TS time is t_{TS}, the reception cycle period T has a relationship of the following equation with the number of groups d

T=t_{TS}×BW_{network}/BW_{in_max} Equation (5)

The following relationship is further obtained from the Equations (2) to (5).

T×BW_{switch_avg}=t_{TS}×F×BW_{network} Equation (6)

A relationship between the average bandwidth BW_{switch_avg} for the ASIC switch and the total bandwidth BW_{network} of the network in Equation (6) through the coefficient F describes scalability of the foregoing network. In Equation (6), the product (right side) of the coefficient F and the BW_{network} is fixed for a given value (left side) of the reception cycle period T and the BW_{switch_avg}. For example, when the total bandwidth BW_{network} of the network varies, the relationship of Equation (6) is maintained by increasing or decreasing the coefficient F in accordance with the variation. In other words, the configuration of the same reception cycle period T and the average bandwidth BW_{switch_avg} of the reception switch can be maintained by varying the setting value of the coefficient F.

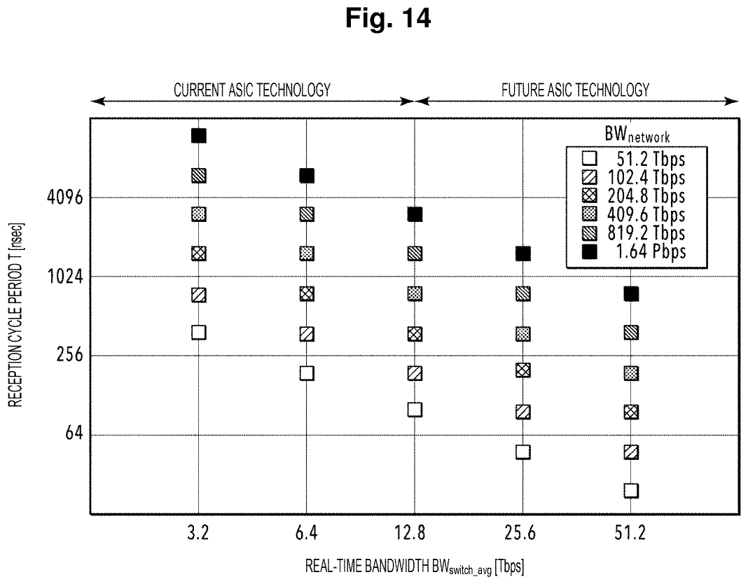

FIG. 14 is a diagram illustrating a relationship between the average bandwidth BW_{switch_avg} of the reception ASIC switch and the reception cycle period T. In FIG. 14, in the DC network into which the coefficient F is introduced, the horizontal axis represents the average bandwidth BW_{switch_avg} (Tbps) of the reception switch, the vertical axis represents the reception cycle period T (nsec), and the relationship between the two is calculated using the total network bandwidth BW_{network} as a parameter. As a precondition of the calculation, the coefficient F indicated in the definition (5) is introduced for the ASIC switch of the reception node, and the average bandwidth BW_{switch_avg} of the ASIC switch is set to 30% (F=0.3) of the maximum incoming bandwidth BW_{in_max} to the node. In addition, six curves are illustrated using the total output bandwidth BWₒᵤₜ per node of 400 Gbps, the time slot time t_{TS} of 40 ns, and the total network bandwidth BW_{network} in the range of 51.2 Tbps to 1.64 Pbps as parameters.

From the graph of FIG. 14, the reception cycle period T becomes shorter as the average bandwidth BW_{switch_avg} of the ASIC switch is larger, and conversely, the reception cycle period T becomes longer as the average bandwidth BW_{switch_avg} of the ASIC switch is smaller. For the average bandwidth BW_{switch_avg} of the reception switch that can be processed in real time, the left plot corresponds to the current level of ASIC technology, and the right plot corresponds to the expected level of ASIC technology in the future. It can be seen that, as the network total bandwidth BW_{network} increases, the reception cycle period T increases. In the time slot scheme of the DC network of the present disclosure, the reception cycle period T is a period until the next data is received, and thus it is desirable that the reception cycle period T be shorter. The graph of FIG. 14 illustrates a relationship in which the ASIC switch average bandwidth BW_{switch_avg} and the network total bandwidth BW_{network} are scalable by the introduction of the coefficient F in Equation (6), including the set value of the reception cycle period T.

A more specific configuration of the node for introducing the “reduced bandwidth” by the coefficient F into the reception ASCI switch will now be further described.

### Processing of Input Traffic Exceeding Average by Extended Reception Cycle Period

When a coefficient F is introduced for the maximum incoming bandwidth BW_{in_max} of the reception node, so that the average bandwidth BW_{switch_avg} of the ASIC switch is a “reduced bandwidth”, input traffic exceeding the average needs to be processed in the ASIC switch. The first idea for processing input traffic exceeding the average is simple and is based on adding one or more time slots that do not actually receive data from any node. This additional time slot is an idle time slot, and an extended reception cycle period is configured.

Referring now again to FIG. 13, (b) of FIG. 13 illustrates two concepts of how to process input traffic exceeding average in the ASIC switch with limited bandwidth by the coefficient F. The first solution in the upper part of (b) of FIG. 13 shows, on a time axis, the configuration of an extended reception cycle period in which an idling time slot 26 that does not receive data from a node in the reception cycle period T is added. This idling time slot 26 allows the reception ASIC switch to perform the switching for the temporary stored additional traffic of input traffic exceeding the average (average bandwidth BW_{switch_avg}). This idling time slot does not actually receive data from any node, is not addressed, and remains in an unassigned state.

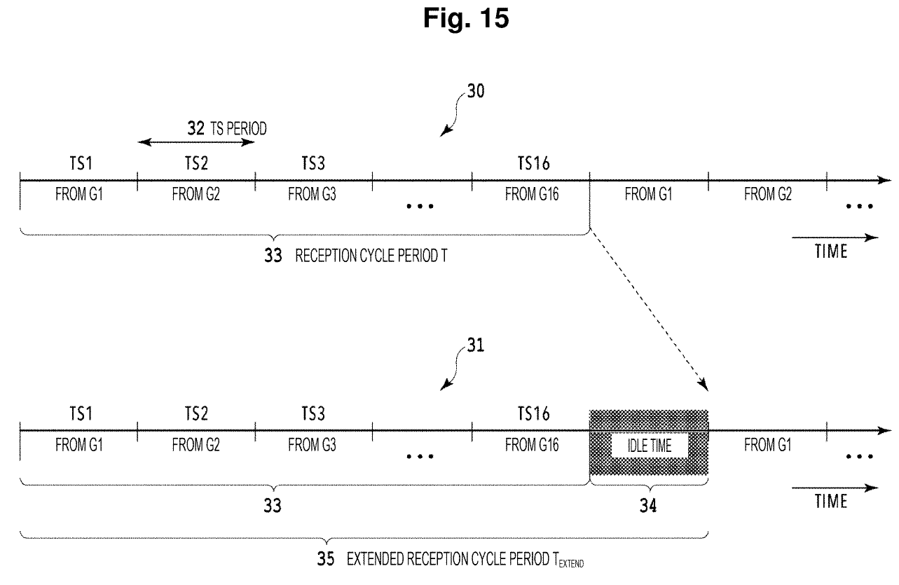

FIG. 15 is a diagram for explaining the configuration of the extended reception cycle period according to introduction of the coefficient F. A time slot configuration 31 of the extended reception cycle is shown along with the normal time slot configuration 30 described in FIGS. 6 and 8. In the example of FIG. 15, the normal time slot configuration 30 includes 16 time slots (TS 1 to TS 16), and one group of 16 groups corresponds to each time slot. In the normal time slot configuration 30, the reception cycle period T 33 is TS time×the number of groups (16).

On the other hand, the extended reception cycle period T_{EXTEND} 35 includes an idle time 34 following the reception cycle period T 33. In FIG. 15, a period corresponding to one time slot is added as the idle time 34, but the idle time 34 may be a period corresponding to one or more time slots. In the idle time 34, no addressing is made from any network group and no data is received. Additional (excessive) traffic that could not be processed due to input traffic exceeding the average in each time slot can be processed in the reception ASIC switch in the idle time 34. In this solution, the switching processing by the ASIC switch is divided into two by the time in the extended reception cycle period T_{EXTEND} 35. One is processing performed within the range of the average bandwidth BW_{switch_avg} with temporal limitation for each node group in the normal reception cycle period T 33. The other is processing performed without time limitation depending on the belonging node group in the idle time 34. In this solution, it is not necessary to change the configuration of the reception node, and traffic exceeding the average bandwidth BW_{switch_avg} can be processed in the idle time 34 by using the storage means 19 illustrated in FIG. 9.

An optical network of the present disclosure can be implemented as including: an optical core portion having a full mesh network configuration; and a plurality of nodes connected to the optical core portion, the plurality of nodes being divided into a plurality of groups, one group including up to m nodes, in which each of the plurality of nodes includes an ASIC switch that switches and routes an electrical signal corresponding to an optical signal received from the up to m nodes to a plurality of servers, the ASIC switch having switching capacity corresponding to average incoming traffic of the plurality of nodes, is addressed by any node in a group to which a source node belongs only in a time slot 33 associated with the group to which the source node belongs in a reception cycle period including a plurality of time slots, and in one or more idle time slots 34 following the plurality of time slots, does not receive an optical signal from any of the source node and processes traffic beyond the average incoming traffic.

Here, i is an index of a time slot, and an input bandwidth in each time slot of one reception cycle period T is set as BWᵢ. The amount of traffic arriving at the ASIC switch changes for each time slot, and the difference between the BWᵢ and the average bandwidth BW_{switch_avg} is expressed as ΔBWᵢ. When adding S idle time slots as the idle time 34, maximum additional traffic that can be processed by the reception ASIC switch is limited as in the following equation. The following equation averages the additional traffic along one reception cycle period T.

$${\sum }_{i} Δ {BW}_{i} \leq ( S \times {BW}_{{switch}_{avg}} ) \qquad Equation ( 7 )$$

In order to process more additional traffic to be the excess bandwidth for the already given value of the average bandwidth BW_{switch_avg}, it is necessary to increase the number of idle time slots to be added, 5, as is clear from equation (7).

When an idle time slot is added, an extended reception cycle period T_{EXTEND} is extended, which is not preferable because a delay is added to an operation cycle of the entire network. Then, from another point of view, a solution is proposed in which when the average bandwidth BW_{switch_avg} of the ASIC switch is a “reduced bandwidth”, input traffic exceeding the average is processed.

### [Modified Configuration in Which Auxiliary Switch is Added to Main Switch]

Referring again to the lower diagram in (b) of FIG. 13, the concept of another second solution is shown for processing input traffic exceeding average in the ASIC switch with limited bandwidth by the coefficient F. In the second solution, when introducing the coefficient F and making the average bandwidth BW_{switch_avg} of the ASIC switch a “reduced bandwidth”, the ASIC switch includes an auxiliary switch 27 in addition to the main ASIC switch in order to process the input traffic that exceeds the average. Rather than a time axis approach as in the first solution, the second solution is an approach of including the main switch and the auxiliary switch 27 of different functions to modify the operation of the switching. While the main switch is a high-speed switch having performance of the state of the art at that time, the auxiliary switch 27 has a bandwidth narrower than that of the main switch as described later, and a slower switch can be used.

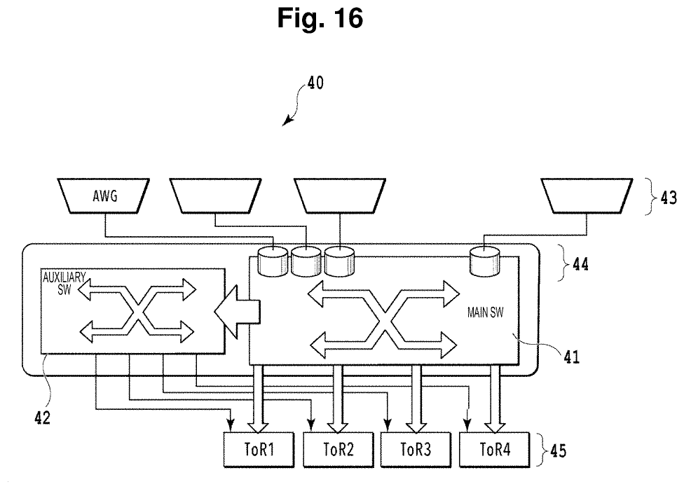

FIG. 16 is a diagram for explaining the configuration of the ASIC switch modified with the introduction of the coefficient F. FIG. 16 illustrates a reception node 40 with a modified configuration of the ASIC switch, which is identical to the configuration of the reception node having the basic configuration of the DC network according to the present disclosure illustrated in FIGS. 4 and 9. That is, the ASIC switch includes the AWG 43 of number m corresponding to the number of nodes in one group in the front part of the node, and includes corresponding receivers 44. The node 40 includes an auxiliary switch 42 in addition to the main switch 41. The main switch 41 is a high-speed and broadband ASIC switch similarly to the reception node of the basic configuration of FIGS. 4 and 9, and is responsible for processing the average bandwidth BW_{switch_avg} reduced by the coefficient F. On the other hand, the auxiliary switch 42 is a low-speed switch having a narrow bandwidth set to 1/q with respect to the bandwidth of the main switch 41. The main switch 41 operates under a time limit by the time slot scheme described in FIGS. 6 and 8, but the auxiliary switch 42 can be used without a time limit over the entire reception cycle period T. The main switch 41 and the auxiliary switch 42 are controlled by a control unit of a node not illustrated in FIG. 16, and two switches having different bandwidths operate in cooperation.

Accordingly, an optical network of the present disclosure can be implemented also as including: an optical core portion having a full mesh network configuration; and a plurality of nodes connected to the optical core portion, the plurality of nodes being divided into a plurality of groups, one group including up to m nodes, in which each of the plurality of nodes is addressed by any node in a group to which a source node belongs only in a time slot associated with the group to which the source node belongs in a reception cycle period including a plurality of time slots, includes ASIC switches that switch and route an electrical signal corresponding to an optical signal received from the up to m nodes to a plurality of servers, and includes as the ASIC switches, a main switch 41 that has switching capacity corresponding to average incoming traffic of the plurality of nodes, and operates in synchronization with the time slot, and an auxiliary switch 42 that has switching capacity capable of processing traffic exceeding the average incoming traffic and operates regardless of the time slot.

Since the auxiliary switch 42 can be used for the reception cycle period T without being limited in time, the maximum additional traffic that can be processed by the auxiliary switch is found as follows. An input bandwidth in each time slot of one reception cycle period T is referred to as BWᵢ. The traffic arriving at the ASIC switch changes for each time slot, and the difference between the BWᵢ and the average bandwidth BW_{switch_avg} is expressed as ΔBWᵢ. The number of time slots in the reception cycle period T is expressed as d (the number d of time slots also corresponds to the number of groups of nodes). The maximum additional traffic by the ASIC switch having the modified configuration of FIG. 16 is subject to the following limitations.

$${\sum }_{i} Δ {BW}_{i} \leq ( \frac{d}{q} \times {BW}_{{switch}_{avg}} ) \qquad Equation ( 8 )$$

From Equation (8), the additional traffic ΔBWᵢ within the reception cycle period T is rather enhanced by the coefficient d/q on the right-hand side, for example, given q=4 and d=16, an extension coefficient of d/q=4 is achieved. Compared with Equation (7) in the first solution in which the reception cycle period T is extended by adding an idle time, input traffic exceeding an average bandwidth can be processed without adding an idle time slot. Further modifications to the configuration of the ASIC switch operating with “reduced bandwidth” by the coefficient F make it possible to process input traffic exceeding average and even enhance the amount of excess bandwidth without causing the delay problems in the first solution.

It is also possible to combine the second solution with the modified configuration of the SAIC switch described above with the first solution of extending the reception cycle period T described above. That is, the extended reception cycle period in which the idling time slot is added in FIG. 15 may be provided and two switches 41, 42 having different bandwidths as illustrated in FIG. 16 may be provided. In this case, each of the nodes of the network receives no optical signal from any source node in one or more idle time slots subsequent to the plurality of time slots, and processes traffic beyond the average incoming traffic. At the same time, the auxiliary switch 42 will process traffic exceeding the average incoming traffic throughout all periods of the plurality of time slots and the one or more idle time slots.

### Minimization of Queuing Time After Switching by Auxiliary Switch

In the second solution with the configuration of the modified ASIC switch of FIG. 16 described above, the cause of the latency (delay) encountered by the traffic passing through the path of the auxiliary switch can be divided into two. The first cause is the latency due to the long physical switching time due to the narrow bandwidth of the auxiliary switch 42. The second cause is latency due to extra latency for the queue until the transmission to the top of rack (ToR) switch 45 is complete. In the following, further modifications are made to the second solution of FIG. 16 to propose a configuration that addresses these delays caused by the auxiliary switch 42.

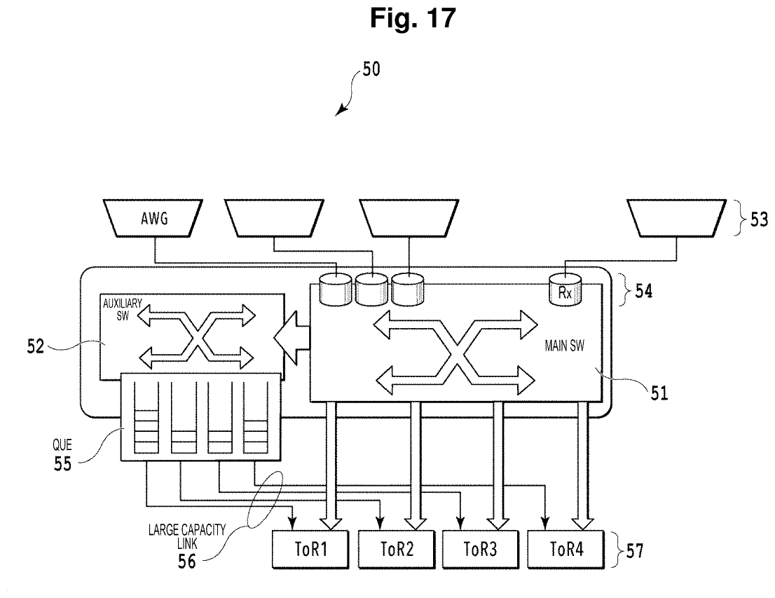

FIG. 17 is a configuration diagram of a node that reduces a delay in the modified ASIC switch. Since the reception node 50 having the modified ASIC switch in FIG. 17 and the reception node 40 described in FIG. 16 have substantially the same configuration, only the difference will be described. The queue 55 in the auxiliary switch 52 is also included in the reception node 40 in FIG. 16 and corresponds to the queue in the delay for the second reason described above. In the reception node 50 of FIG. 17, the auxiliary switch 52 and the ToR switch 57 are connected via a link 56 having a large transmission capacity that can be implemented as an optical link. The configuration of FIG. 17 can support sufficient capacity to transmit data accumulated within one time slot to a target ToR switch and reduce the delay on the modified ASIC switch.

As described above in detail, the optical network of the present disclosure can simplify the configuration of the node in the peripheral part of the DC network and reduce the power consumption. The optical network of the present disclosure can solve or at least reduce a problem of the ASIC switch and to cope with large-scale and low power consumption of the optical network. In addition, corresponding to various limitations of the ASIC switch, scalability is implemented to flexibly adapt to network traffic demand and technological progress of a realistic ASIC switch.

### INDUSTRIAL APPLICABILITY

In general, the present invention can be applied to an optical communication system.

1. An optical network comprising:
an optical core portion having a full mesh network configuration; and
a plurality of nodes connected to the optical core portion, the plurality of nodes being divided into a plurality of groups, one group including up to m nodes,
wherein each of the plurality of nodes
includes an ASIC switch that switches and routes an electrical signal corresponding to an optical signal received from the up to m nodes to a plurality of servers, the ASIC switch having switching capacity corresponding to average incoming traffic of the plurality of nodes,
is addressed by any node in a group to which a source node belongs only in a time slot associated with the group to which the source node belongs in a reception cycle period including a plurality of time slots, and
in one or more idle time slots subsequent to the plurality of time slots, does not receive an optical signal from any of the source node and processes traffic beyond the average incoming traffic.

2. An optical network comprising:
an optical core portion having a full mesh network configuration; and
a plurality of nodes connected to the optical core portion, the plurality of nodes being divided into a plurality of groups, one group including up to m nodes,
wherein each of the plurality of nodes
is addressed by any node in a group to which a source node belongs only in a time slot associated with the group to which the source node belongs in a reception cycle period including a plurality of time slots,
includes ASIC switches that switch and route an electrical signal corresponding to an optical signal received from the up to m nodes to a plurality of servers, and
includes as the ASIC switches, a main switch that has switching capacity corresponding to average incoming traffic of the plurality of nodes, and operates in synchronization with the time slot, and
an auxiliary switch that has switching capacity capable of processing traffic exceeding the average incoming traffic and operates regardless of the time slot.

3. The optical network according to claim 2, wherein each of the plurality of nodes,
in one or more idle time slots subsequent to the plurality of time slots, does not receive optical signals from any of the source nodes and processes traffic exceeding the average incoming traffic, and
the auxiliary switch processes traffic exceeding the average incoming traffic throughout all periods of the plurality of time slots and the one or more idle time slots.

4. The optical network according to claim 2, wherein each of the plurality of nodes further includes an additional optical link that connects the auxiliary switch and a top of rack switch including the plurality of servers.

5. The optical network according to claim 1, wherein each of the plurality of nodes further includes:
m arrayed waveguide gratings (AWGs), the AWGs including a plurality of input ports configured to receive corresponding optical signals from the up to m nodes belonging to a same group, and having wavelengths used by one or more source nodes of the up to m nodes set to match operating wavelengths of the plurality of input ports;
m receivers connected to output multiplexing ports of the AWGs; and
a storage medium that stores and processes traffic exceeding the switching capacity.

6. The optical network according to claim 1, wherein a maximum incoming bandwidth to each of the plurality of nodes is BW_{in_max}, and
the ASIC switch is assigned an average bandwidth BW_{switch_avg}=F×BW_{in_max} which is a reduced bandwidth by a coefficient F (0<F<1) and corresponds to the average incoming traffic.

7. The optical network according to claim 3, wherein each of the plurality of nodes further includes an additional optical link that connects the auxiliary switch and a top of rack switch including the plurality of servers.

8. The optical network according to claim 2, wherein each of the plurality of nodes further includes:
m arrayed waveguide gratings (AWGs), the AWGs including a plurality of input ports configured to receive corresponding optical signals from the up to m nodes belonging to a same group, and having wavelengths used by one or more source nodes of the up to m nodes set to match operating wavelengths of the plurality of input ports;
m receivers connected to output multiplexing ports of the AWGs; and
a storage medium that stores and processes traffic exceeding the switching capacity.

9. The optical network according to claim 3, wherein each of the plurality of nodes further includes:
m arrayed waveguide gratings (AWGs), the AWGs including a plurality of input ports configured to receive corresponding optical signals from the up to m nodes belonging to a same group, and having wavelengths used by one or more source nodes of the up to m nodes set to match operating wavelengths of the plurality of input ports;
m receivers connected to output multiplexing ports of the AWGs; and
a storage medium that stores and processes traffic exceeding the switching capacity.

10. The optical network according to claim 4, wherein each of the plurality of nodes further includes:
m arrayed waveguide gratings (AWGs), the AWGs including a plurality of input ports configured to receive corresponding optical signals from the up to m nodes belonging to a same group, and having wavelengths used by one or more source nodes of the up to m nodes set to match operating wavelengths of the plurality of input ports;
m receivers connected to output multiplexing ports of the AWGs; and
a storage medium that stores and processes traffic exceeding the switching capacity.

11. The optical network according to claim 2, wherein a maximum incoming bandwidth to each of the plurality of nodes is BW_{in_max}, and
the ASIC switch is assigned an average bandwidth BW_{switch_avg}=F×BW_{in_max} which is a reduced bandwidth by a coefficient F (0<F<1) and corresponds to the average incoming traffic.

12. The optical network according to claim 3, wherein a maximum incoming bandwidth to each of the plurality of nodes is BW_{in_max}, and
the ASIC switch is assigned an average bandwidth BW_{switch_avg}=F×BW_{in_max} which is a reduced bandwidth by a coefficient F (0<F<1) and corresponds to the average incoming traffic.

13. The optical network according to claim 4, wherein a maximum incoming bandwidth to each of the plurality of nodes is BW_{in_max}, and
the ASIC switch is assigned an average bandwidth BW_{switch_avg}=F×BW_{in_max} which is a reduced bandwidth by a coefficient F (0<F<1) and corresponds to the average incoming traffic.

14. The optical network according to claim 5, wherein a maximum incoming bandwidth to each of the plurality of nodes is BW_{in_max}, and
the ASIC switch is assigned an average bandwidth BW_{switch_avg}=F×BW_{in_max} which is a reduced bandwidth by a coefficient F (0<F<1) and corresponds to the average incoming traffic.
